(19) United States
(12) Patent Application Publication
(10) Pub. No.: US 2013/0144424 A1
(43) Pub. Date: Jun. 6, 2013

(54) GARMENT PRODUCTION SYSTEM

(71) Applicant: Stephane Jarbouai, Berkeley, CA (US)

(72) Inventor: Stephane Jarbouai, Berkeley, CA (US)

(21) Appl. No.: 13/681,287

(22) Filed: Nov. 19, 2012

Related U.S. Application Data
(60) Provisional application No. 61/561,207, filed on Nov. 17, 2011.

(51) Int. Cl. G06F 9/06

(52) U.S. Cl. CPC G06F 9/06
USPC 700/134

(57) ABSTRACT

A system for producing a garment on demand according to a selected garment design and a wearer's measurements. The system can cut garment pieces from material according to the selected garment design, and can couple the garment pieces together to assemble the garment. Transport mechanisms can manipulate the garment pieces during cutting and assembly of the garment.

### CLAIM OF PRIORITY

This Application claims priority under 35 U.S.C. §119(e) from earlier filed U.S. Provisional Application Ser. No. 61/561,207, filed Nov. 17, 2011, by Stephane Jarbouai, the entirety of which is incorporated herein by reference.

### BACKGROUND

1. Field of the Invention

The present invention relates generally to producing garments, and in particular to a system for producing garments on demand.

2. Background

Traditionally, customers who desire to purchase clothing have needed to travel to a store, browse through garments that the store has in stock, and try on garments in an attempt to find a garment that has a design that the customer desires and that also fits the customer's measurements. Customers can also purchase clothing from mail order catalogs or websites, however a customer who uses these methods has no way of trying on the garment to see if it fits until after it has been purchased and is shipped to the customer. Customers can choose to buy ill-fitting clothing and have the garments later tailored to fit the customer's measurements, but this process can be expensive and time consuming. Customers can also choose to have custom fitted garments made for them, but this again can be expensive and time consuming.

Traditional methods of buying and selling clothing can also be inefficient for clothing stores and other merchants. A store that misjudges the consumer demand for a particular style or size of a particular garment design can be left with too much or too little stock on hand at any time. In some situations, merchants purchase and keep certain garment designs and sizes in stock even if they are not sure that the garments will be sold. If the store misjudges consumer demand, the store can also sell out of popular sizes of a particular garment design, prompting complaints from customers.

What is needed is a machine for producing garments on demand when a customer wishes to purchase a garment or a store needs to stock more garments, such that the garment will fit the customer and the store does not need to keep extra stock on hand. In some embodiments the machine can be located within a store such that the garment can be produced locally as needed, eliminating the time the customer or store would need to wait for the garment to be shipped from a remote location. In alternate embodiments, the machine can be located in any location and can produce garments automatically.

### BRIEF DESCRIPTION OF THE DRAWINGS

FIG. 1 depicts an exemplary embodiment of a garment.

FIG. 2 depicts a block diagram of an exemplary embodiment of a garment design.

FIG. 3 depicts an exemplary embodiment of a garment producing machine having separate cutting areas and assembly areas.

FIG. 4 depicts an exemplary embodiment of a garment producing machine having combined cutting areas and assembly areas.

FIG. 5 depicts an exemplary embodiment of exchangeable robot hands.

FIG. 6 depicts a flow chart of a process for producing a garment using a garment producing machine.

FIG. 7 depicts a flow chart of a method of producing a garment on demand for a customer.

FIG. 8 depicts an exemplary embodiment of computer hardware.

### DETAILED DESCRIPTION

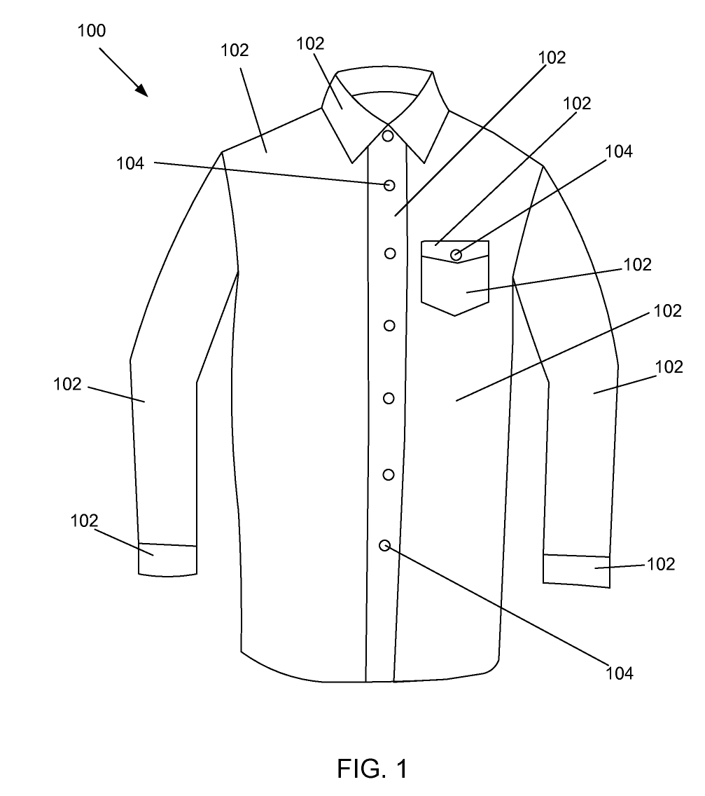

FIG. 1 depicts an embodiment of a garment 100. A garment 100 can be an article of clothing, such as a shirt, coat, dress, skirt, pair of pants, or any other type of clothing. A garment 100 can be comprised of garment pieces 102 and notions 104. The garment pieces 102 can be sections of the garment 100 that can be sewn together and/or coupled with one another to create the garment 100. Each garment piece 102 can comprise a material such as fabric, cloth, denim, fur, leather, nylon, polyester, elastane, silk, linen, cotton, wool, fleece, textile, or any other natural or synthetic material desired to be used in a garment 100. Notions 104 can be functional and/or ornamental accessories that can be coupled with the garment 100, such as buttons, zippers, beads, snaps, collar stays, patches, embellishments, buckles, chains, feathers, or any other accessories.

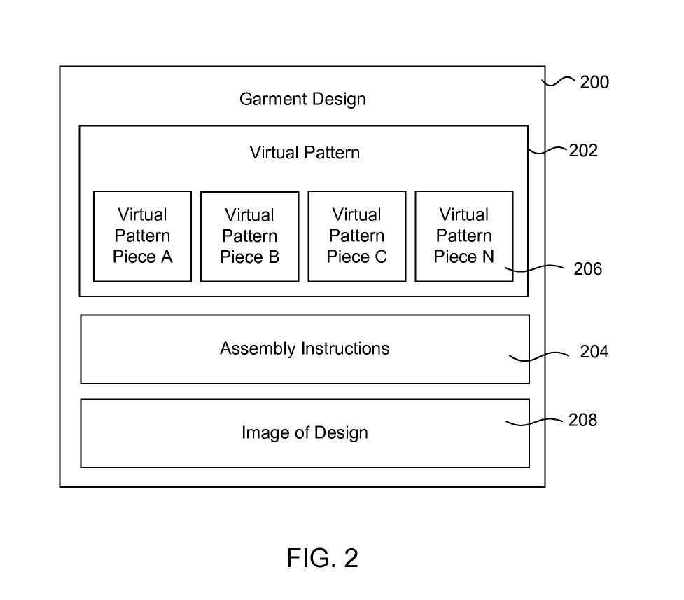

FIG. 2 depicts a block diagram of a garment design 200. A garment design 200 can comprise machine readable information about a specific garment 100. Each garment design 200 can comprise a virtual pattern 202 and assembly instructions 204. The virtual pattern 202 can comprise a plurality of virtual pattern pieces 206. Each virtual pattern piece 206 can be a machine readable representation of a specific garment piece 102 that can be coupled with other garment pieces 102 to create a garment 100 that matches the virtual pattern 202. Each virtual pattern piece 206 can describe the dimensions of a garment piece 102, the type of material of the garment piece 102, the type of pattern and/or orientation of the pattern appearing on the material for the garment piece 102, and/or any other attributes of the garment piece 102. The assembly instructions 204 can be machine readable instructions that can be followed by a garment production system 300 to assemble the garment 100. In some embodiments, the garment design 200 can also comprise an image 208 of the garment 100 described by the garment design 200.

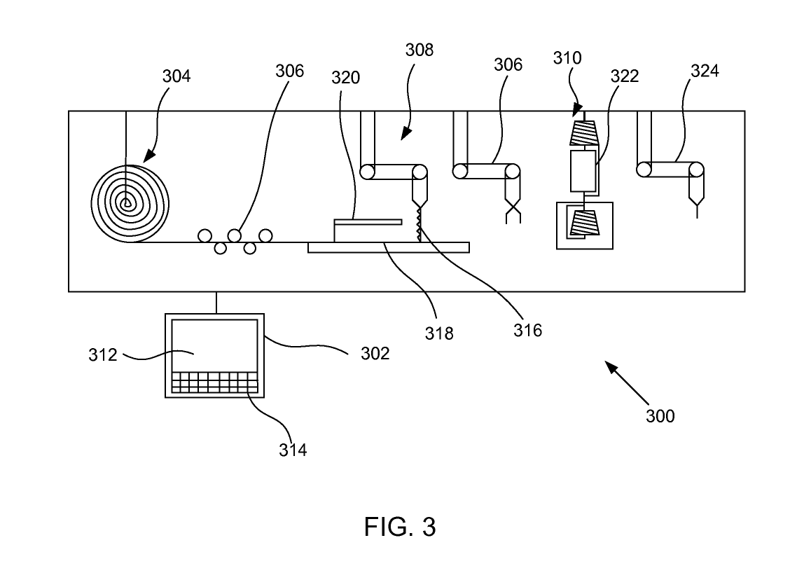

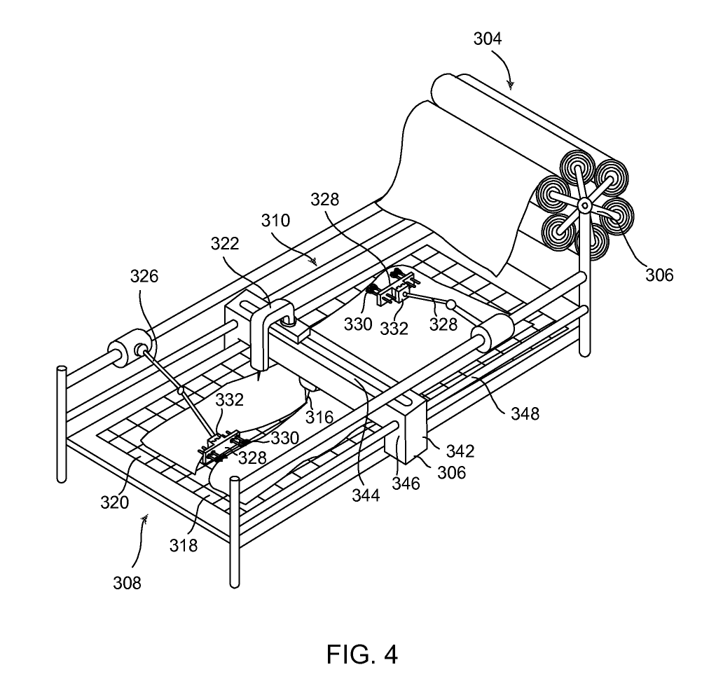

FIGS. 3 and 4 depict exemplary embodiments of a garment production system 300. The garment production system 300 can be a machine comprising a terminal 302, a storage area 304, one or more transport mechanisms 306, a cutting area 308, and/or an assembly area 310. The terminal 302 can comprise a display 312 and one or more input devices 314. An input device 314 can be a keyboard, mouse, stylus, barcode scanner, optical scanner, camera, touchscreen, or any other device capable of receiving input. In some embodiments, one or more of the input devices 314 can be measuring devices capable of taking measurements of a human body, such as 3D scanners, optical scanners, cameras, infrared scanners, laser scanners, robotic arms that can move to both sides of an object being measured and determine the distance between the robotic arms, or any other optical or mechanical measuring system. In some embodiments, the terminal 302 can be integral with the garment production system 300. In alternate embodiments, the terminal 302 can be a computer, server, tablet, mobile phone, or any other device external to the garment production system 300 that can be configured to be in communication with the garment production system 300. The terminal 302 can be in communication with the rest of the garment production system 300 via a wired or wireless data connection.

In some embodiments, one or more garment designs 200 can be stored in memory locally in the terminal 302 or in another location in the garment production system 300. In some embodiments, garment designs 200 can be read from removable media, or be uploaded or transmitted to local memory on the garment production system 300 such that the garment production system 300 can have access to new garment designs 200. In other embodiments, garment designs 200 can be stored in memory on a server or external memory in communication with the garment production system 300.

The garment production system 300 can store units of material in the storage area 304. The units of material can be rolls, bolts, sheets, or any other configuration of material. In some embodiments, the garment production system 300 can store units of the types of material that are used in the garment designs 200 stored in or accessible by the garment production system 300. In other embodiments, the garment production system 300 can store units of the types of material that are most frequently used. In still other embodiments, a user can load the garment production system 300 with units of the types of material used in a particular selected garment design 200. When desired, the units of material can be reloaded or replaced within the storage area 304. In alternate embodiments, the garment production system 300 can comprise a loom configured to weave fibers stored within the garment production system 300 into a unit of material.

Transport mechanisms 306 can be located within the storage area 304, the cutting area 308, the assembly area 310, and/or any other location in the garment production system 300. Each transport mechanism 306 can be a device configured to move units of material, garment pieces 102, partially assembled garments 100, and/or notions 104 to desired locations or positions within the garment production system 300. Transport mechanisms 306 can be conveyor belts, rollers, unrollers, robotic arms, movable platforms, motorized bars, movable clamps, and/or any other device. In some embodiments, at least one transport mechanism 306 can be of a different type than one or more other transport mechanism 306.

One or more of the transport mechanisms 306 can be robotic arms. In some embodiments, the robotic arms can comprise one or more segments 326, one or more hands 328, and/or one or more grips 330. The segments 326 and/or hands 328 can be coupled with one another via motorized hinges and/or joints, such that the segments 326 and hands 328 can be rotated and/or manipulated to move the hands 328 into any desired orientation and position. In some embodiments, the garment production system 300 can comprise a plurality of robotic arms coupled with the bottom, top, and/or sides of the garment production system 300. In some embodiments, the bases of the robotic arms can be coupled with the garment production system 300 in fixed locations. In alternate embodiments, the bases of the robotic arms can be movable.

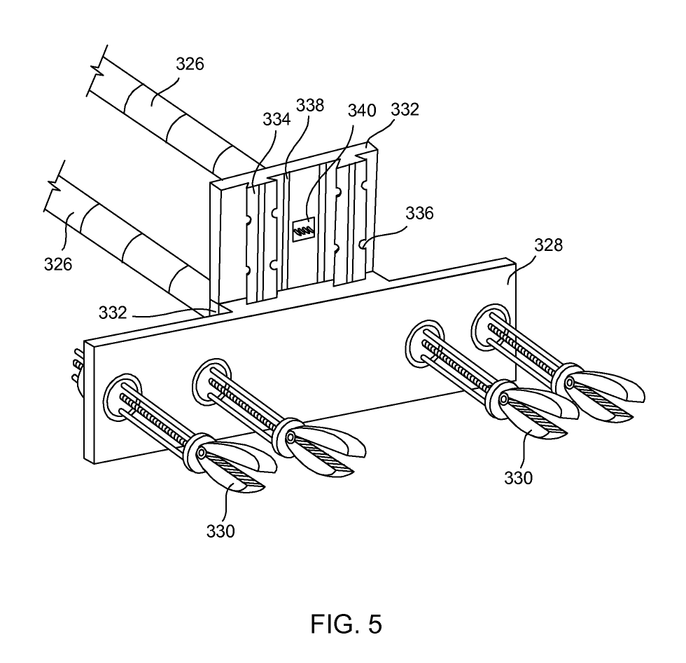

FIG. 5 depicts a close up view of an exemplary embodiment of two robotic arms configured to be slideably coupled with a hand 328. In some embodiments, the hands 328 can be removable from the segments 326, such that the hands 328 can be transferred between different robotic arms and/or be replaced with hands 328 having different types of grips 330, replacement hands 328, or other tools. The robotic arms can be terminated with an arm faceplate 332 comprising one or more connectors 334. The hands 328 can comprise corresponding connectors 334, such that the connectors 334 of the hands 328 can mate with the connectors 334 of the arm faceplate 332. In some embodiments, the connectors 334 can be interlocking protrusions and grooves, such that a hand 328 can slide from the arm faceplate 332 of a first robot arm to the arm faceplate 332 of a second robot arm when the connectors 334 are aligned, as shown in FIG. 5. The grooves and protrusions can have notches 336, nubs, stops, or be otherwise shaped such that the hand 328 can snap and/or lock into position on the arm faceplate 332. In alternate embodiments, the connectors can be magnets, clamps, slots, threaded connections, snaps, interlocking components, or any other connection mechanism.

The arm faceplate 332 and the hands 328 can comprise corresponding contacts 338. The contacts 338 can be a conducting material capable of transmitting electricity and/or data between the hand 328 and the arm faceplate 332 in order to power and control components of the hands 328. In some embodiments, the contacts 338 can be copper. In alternate embodiments, the contacts 338 can be silver, aluminum, or any other conducting material. In some embodiments, contacts 338 can be provided to transmit power and data separately. In alternate embodiments, the same contacts 338 can be configured to transmit both power and data. In still other embodiments, the hand 328 and arm faceplate 332 can further comprise corresponding data ports 340 configured to transmit data signals and/or power.

Grips 330 can be devices configured to grasp units of material, garment pieces 102, and/or notions 104. One or more grips 330 can be coupled with each hand 328. In some embodiments, the grips 330 can be crocodile style clips that can be mechanically opened and closed to grasp material between the two sides of the crocodile style clips. In alternate embodiments, the grips 330 can be robotic fingers, pins, clips, or any other type of grip. In some embodiments comprising a plurality of grips 330 on a hand 328, each grip 330 on the hand 328 can be moved independently. By way of a non-limiting example, an individual hand 328 can grasp a garment piece 102 along a curved path by positioning each of its grips 330 at a different point along the curved path. In some embodiments, each grip 330 can be at the end of one or more rods coupled with the hand 328, such that the rod can be extended, contracted, and/or rotated relative to the face of the hand 328 to place the grip 330 in a desired position. In some embodiments the rods can be threaded and extend through apertures in the hand 328 beyond the back face of the hand 328, and a motor can move the threads of the rod to extend, contract, and/or rotate the rod and grip 330. In alternate embodiments, the rods can be collapsible, be coupled to a rotating ring within the hand 328, be spring loaded, or have any other movement mechanism. In some embodiments, the grips 330 can be removable, exchangeable, and/or replaceable. In alternate embodiments, the grips 330 can be integral with the hand 328.

In embodiments in which the hands 328 are removable, the grips 330 of a hand 328 can grasp a garment piece 102, and the hand 328 can be detached from a first robotic arm and be reattached to a second robotic arm, such that the garment piece 102 can be transferred between two robotic arms without introducing errors or wrinkles by attaching different hands 328 and/or grips 330 in different locations on the garment piece 102. By way of a non-limiting example, as shown in FIG. 5 a hand 328 attached to the end of a first robotic arm can be moved adjacent to the end of a second robotic arm, such that the hand 328 can slide from the first robotic arm into a slot in the second robotic arm and be locked into place coupled with the second robotic arm.

One or more of the transport mechanisms 306 can be movable bars 342. Movable bars 342 can comprise one or more bars 344, one or more motors 346, and one or more rails 348. In some embodiments, the rails 348 can be straight. In alternate embodiments, the rails 348 can be curved or have any other shape. The bars 344 can be coupled with one or more rails 348, and can be propelled by one or more motors 346 to slide along the rails 348. By way of a non-limiting example, FIG. 4 depicts a movable bar 342 that is slidably coupled with rails 348 on both ends of the bar 344, such that the movable bar 342 is in the form of a bridge.

In some embodiments, the motors 346 can be stepper motors. In alternate embodiments, the motors 346 can be servomotors, DC motors, AC motors, universal motors, rotary motors, or any other type of motor.

One or more attachments can be coupled with a movable bar. The attachments can be components of the garment production system 300, such as assembly devices 322, cutting tools 316, bases of robotic arms or other transport mechanisms 306, or any other devices. By way of a non-limiting example, in FIG. 4 a sewing machine attachment and a laser cutter attachment are coupled with the movable bar 342. In some embodiments, the attachment can be fixed on the movable bar 342. In other embodiments, the attachment can extend from the movable bar 342, be rotatable relative to the movable bar 342, and/or be propelled by a motor 346 to slide along the length of the bar 344. In these embodiments, the combination of the movable bar 342 and movable attachment can allow the attachment to be moved to any position on a two dimensional plane, by moving the movable bar 342 along the rail 348 in one axis and moving the attachment along the bar 344 in a perpendicular axis, and rotating and/or extending the attachment. In some embodiments, the position of the movable bar 342 and/or attachment can also be adjusted along a third axis, allowing the attachment to be positioned at any point in three dimensional space within the garment production system 300.

The cutting area 308 can be a space within the garment production system 300 in which a unit of material is cut into one or more garment pieces 102. In some embodiments, the garment production system 300 can comprise one cutting area 308. In alternate embodiments, the garment production system 300 can comprise more than one cutting area 308 such that multiple different garment pieces 102 can be cut at the same time. Each cutting area 308 can comprise a cutting surface 318. The cutting surface 318 can be a table, slab, platform, or any other flat surface. In some embodiments the cutting surface 318 can be a grid of rigid bars, such that there are spaces between adjacent bars. In alternate embodiments the cutting surface 318 can be solid, rigid, semi-rigid, padded, define a plurality of apertures, or be any other desired surface.

In some embodiments the cutting area 308 can further comprise at least one tensioning mechanism 320. The tensioning mechanism 320 can be configured to hold a unit of material in place. In some embodiments, the tensioning mechanism 320 can comprise fans, vacuums, and/or vents that can move air through or against the cutting surface 318, such that material can be kept in place against the cutting surface 318, keep the unit of material taut, and/or eliminate wrinkles in the material. By way of a non-limiting example, in FIG. 4 the tensioning mechanism 320 is a vacuum table integrated with the cutting surface 318 that can suck air from above the cutting surface 318 downward through the cutting surface 318 through apertures or spaces between gridded bars. In alternate embodiments, the tensioning mechanism 320 can be a transport mechanism 306 such as a robotic arm configured to hold and/or move the material while the material is cut. In still other embodiments, the tensioning mechanism 320 can be a bar, press, iron, roller, frame, blower, clip, or any other device capable of holding material in place.

Each cutting area 308 can comprise one or more cutting tools 316. The one or more cutting tools 316 can be blades, die cutters, laser cutters, or any other device capable of cutting material into a desired shape. In some embodiments the one or more cutting tools 316 can be an attachment coupled with a transport mechanism 306, such that the cutting tool 316 can be moved relative to a unit of material. By way of a non-limiting example, in FIG. 4 the assembly device 322 is a laser cutter mounted on the underside of the movable bar 342. The laser cutter can move via a motor 346 to any position along the length of the movable bar 342. In some embodiments the cutting tool 316 can be moved relative to a unit of material held stationary on the cutting surface 318 by transport mechanisms 306 and/or tensioning mechanisms 320. In other embodiments, the cutting tool 316 can be stationary within the cutting area 308 while a transport mechanism 306 moves the unit of material relative to the cutting tool 316. In still other embodiments, both the cutting tool 316 and the unit of material can be moved independently and/or simultaneously during cutting in two and/or three dimensions.

In some embodiments, the garment production system 300 can comprise an assembly area 310 separate from the cutting area 308. By way of a non-limiting example, FIG. 3 depicts an assembly area 310 separate from the cutting area 308. In alternate embodiments, the assembly area 310 can be the same as the cutting area 308. By way of a non-limiting example, FIG. 4 depicts a cutting area 308 that can also be used as an assembly area 310. In some embodiments, the assembly area 310 and/or cutting area 308 can comprise a temporary staging area in which garment pieces 102 and/or portions of partially assembled garments 100 can be stored when not being used during production of the garment 100. The temporary staging area can be shelves, hooks, hangers, platforms, a portion of the cutting surface, or any other location.

The assembly area 310 can comprise an assembly device 322 configured to couple two or more garment pieces 102 together. In some embodiments, the assembly device 322 can be a sewing machine configured to sew two or more garment pieces 102 together with stitches and/or seams. In alternate embodiments, the assembly device 322 can glue, staple, fuse, or use any other desired coupling method to couple garment pieces 102 with one another. In some embodiments, the garment production system 300 can comprise multiple assembly devices 322 each configured to use a different coupling method. In alternate embodiments, some or all the assembly devices 322 can be configured to use the same or different coupling methods. Some assembly devices can couple garment pieces 102 together using a connection material. The connection material can be thread, yarn, glue, staples, or any other coupling item specified by the garment design 200. In some embodiments the connection material can be stored within the garment production system 300 in spools, bobbins, or any other storage container. The connection material can be replaced or reloaded by a user.

In some embodiments, the assembly device 322 can be mounted on a transport mechanism 306, such that the assembly device can be moved a suitable location to couple garment pieces 102. By way of a non-limiting example, in FIG. 4 the assembly device 322 is a sewing machine mounted on the movable bar 342. The sewing machine can move via a motor 346 to any position along the length of the movable bar 342, and can extend and/or rotate to a desired orientation. In some embodiments, the assembly area 310 can also comprise one or more transport mechanisms 306 configured to move garment pieces 102 into a desired position within the assembly area 310. The transport mechanisms 306 can move or position the garment pieces 102 together proximate to the assembly device 322, such that the assembly device 322 can couple the garment pieces 102. In some embodiments the assembly device 322 can be moved relative to garment pieces 102 held stationary by the transport mechanisms 306 and/or tensioning mechanisms 320. In other embodiments, the assembly device 322 can be stationary while transport mechanisms 306 move the garment pieces relative to the assembly device 322. In still other embodiments, both the assembly device 322 and the garment pieces 102 can be moved independently and/or simultaneously during assembly in two and/or three dimensions.

In some embodiments, the assembly area 310 can comprise one or more notion attachment devices 324. The notion attachment devices 324 can be configured to attach notions 104 to the garment 100 or garment pieces 102. The notion attachment devices 324 can be sewing machines, irons, punches, presses, or any other device capable of attaching notions 104 to a garment 100. In some embodiments, the notion attachment devices 324 can be mounted on transport mechanisms 306, such as robotic arms.

In some embodiments, the cutting areas 308 and/or assembly areas 310 can comprise one or more marking devices. The marking devices can be nozzles, sprayers, or any other device capable of making markings on a garment piece 102. In some embodiments, marking devices can be mounted on transport mechanisms 306 such as robotic arms. The marking devices can be configured to mark each garment piece 102 with one or more assembly markings. The assembly markings can be markings that indicate to the garment production system 300 the locations on each garment piece 102 to which other garment pieces 102 should be sewn or coupled with the garment piece 102. The assembly markings can be markings that are visible or invisible to the human eye made with tailor's chalk, infrared dye, or any other medium.

In some embodiments, the cutting areas 308 and/or assembly areas 310 can comprise one or more optical sensors. The optical sensors can be cameras, scanners, infrared sensors, or any other optical device. In some embodiments, the optical sensors can track the orientation of a pattern on a unit of material, the position and/or orientation of a garment piece 102, the position and/or orientation of assembly markings on garment pieces 102, and/or any other attribute of the garment pieces 102. The optical sensors can be in communication with the cutting tools 316 and/or transport mechanisms 306 to assist them in manipulating the units of material, garment pieces 102, and notions 104 during cutting and assembly of the garment 100. By way of non-limiting examples, in some embodiments the optical sensors can: verify that a cut garment piece 102 matches the dimensions and specifications of a virtual pattern piece 206; track assembly markings or the position of garment pieces 102 such that the garment pieces 102 are properly positioned next to one another during assembly; verify that a completed garment 100 meets the specifications of the garment design 200; or track any other aspect of the production of the garment 100.

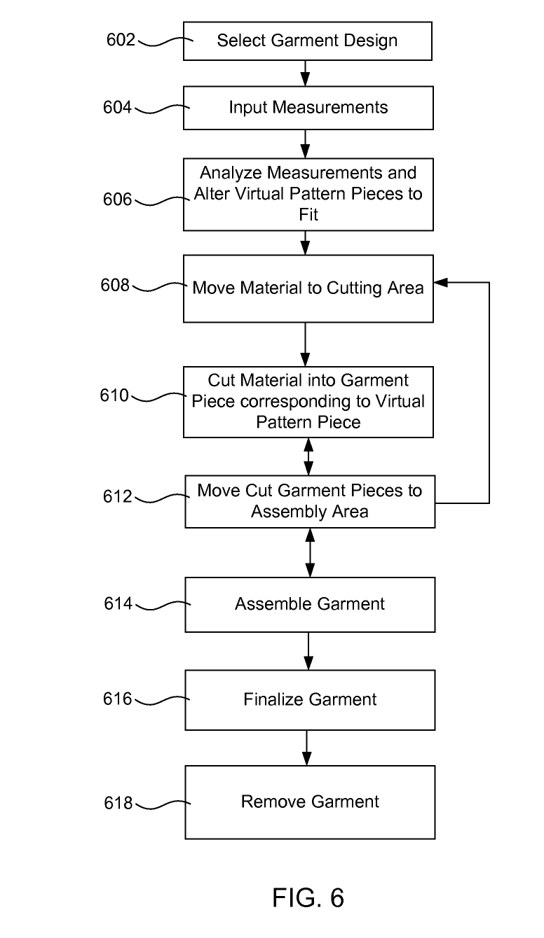

FIG. 6 depicts a flow chart of a process 600 for producing a garment 100 using the garment production system 300. At 602, the user can select a garment design 200 using the terminal 302. In some embodiments, choices of garment designs 200 can be displayed on the display 312, and the user can select options to browse or search garment designs 200 and/or to select a desired garment design 200. In some embodiments the images 208 for the choices of garment designs 200 can be displayed on the display 312. In alternate embodiments, the user can select a desired garment design 200 by entering a stock-keeping unit (SKU) number corresponding to a garment design 200, scanning in a barcode corresponding to a garment design 200, or using any other method of selecting a garment design 200. In some embodiments, the user can use the terminal 302 to add, remove, or change attributes of a selected garment design 200 or any individual virtual pattern piece 206, such as changing the colors, materials, or patterns to be used in the garment 100 or garment pieces 102, adding personalized embroidery or other embellishments, or changing any other attribute of the garment design 200 or the virtual pattern pieces 206. In some embodiments, the garment production system 300 can use an input device 314 such as a camera to obtain an image of the customer such that the garment production system 300 can create and display an image of the customer wearing the garment 100 of the selected or customized garment design 200.

At 604, the user can input measurements into the garment production system 300 using the terminal 302. The measurements can describe the body of an individual who will wear the garment 100. Measurements can include measurements of the chest, waist, hips, arms, legs, length from neck to waist, inseam, and measurements of any other portion of the body that can be used to tailor a garment 100. The types of measurements to be inputted can vary depending on the selected garment design 200.

In some embodiments, a user can enter measurements manually. In alternate embodiments, the garment production system 300 can take the wearer's measurements through an input device 314. In some embodiments, the user can have the option to select default measurements preset as small, medium, large, extra-large, or any other preset size. The default measurements can be preset by the designer of the selected garment 100, an employee of a store or factory in which the garment production system 300 is located, or any other person or entity authorized to change settings on the garment production system 300.

In some embodiments, an input device 314 can be configured to take images of the user's body and display an image of the user's body wearing the garment 100 of the selected garment design 200 on the display 312. In some embodiments, the images can be processed to create a three dimensional image that can be displayed in three dimensions or as a two dimensional image that can be rotated to view the user's body wearing the garment 100 of the selected garment design 200 from any angle.

At 606, the garment production system 300 can analyze the entered measurements and alter the dimensions of one or more virtual pattern pieces 206, including the size and/or the shape of the virtual pattern pieces 206, such that an assembled garment 100 comprising the garment pieces 102 corresponding to the virtual pattern pieces 206 can fit a body described by the measurements. In some embodiments, each virtual pattern piece 206 can have tolerances that can describe extent of possible alterations to the dimensions of that particular virtual pattern piece 206. In some embodiments, the garment production system 300 can alter the dimensions of certain preselected virtual pattern pieces 206. In some embodiments, the garment production system 300 can add or subtract virtual pattern pieces 206 to the virtual pattern 202 in order to create a garment 100 that conforms to the measurements.

At 608, the garment production system 300 can move material to the cutting area 308. The garment production system 300 can use a transport mechanism 306 to move material specified by a virtual pattern piece 206 to the cutting area 308. In some embodiments, a transport mechanism 306 can move a portion of a unit of fabric to the cutting area 308, where a cutting tool 316 can sever the portion of the unit of fabric. By way of a non-limiting example, in the embodiment shown in FIG. 4, a unit of material can be rotated into position to be partially unrolled onto the cutting surface 318, and the cutting tool 316 can sever a portion of the unrolled material from the unit of material. In other embodiments, a portion of the unit of material can be severed from the rest of the unit of material in the storage area 304, and then be moved to the cutting area 308. By way of a non-limiting example, the garment production system 300 can sever a square yard of fabric from a roll of fabric in the storage area 304, and transport the square yard of fabric to the cutting area 308. In still other embodiments, the entire unit of material can be moved to the cutting area 308. The garment production system 300 can move enough material to the cutting area for one garment piece 102 or more than one garment piece 102.

At 610, the garment production system 300 can cut out a garment piece 102 from having dimensions described by a virtual pattern piece 206 from the material within the cutting area 308. In some situations, the cutting tool 316 can cut the garment piece 102 directly from a full unit of material. In other situations, the cutting tool 316 can cut the garment piece 102 from a portion of material previously severed from a unit of material. In some embodiments, the garment production system 300 can orient the material in a specific direction such that any pattern on the unit material can appear on each garment piece 102 in a designated orientation once the garment piece 102 is cut. In some embodiments, an optical scanner can verify proper orientation of the material prior to cutting.

Transport mechanisms 306 and/or tensioning mechanisms 320 can hold the material in place during cutting. By way of a non-limiting example, FIG. 4 depicts a cutting area 308 having a vacuum table which can suck air through the cutting surface to keep the material taut and held against the cutting surface 318. In some embodiments, the interior of the garment piece 102 can be held in place during the cutting. In other embodiments, extra material outside of the garment piece 102 can be held in place during the cutting. In still other embodiments, both the garment piece 102 and any extra material outside of the garment piece 102 can be held in place during the cutting.

The cutting tool 316 can make any additional cuts within the garment piece 102 as specified by the virtual pattern piece 206, such as buttonholes or neck holes. In some embodiments, optical sensors can verify that the dimensions of the cut garment piece 102 match the dimensions described by the virtual pattern piece 206. In some embodiments, if the dimensions of the cut garment piece 102 do not match the dimensions described by the virtual pattern piece 206, the cut garment piece 102 can be discarded or re-used as the material for a different garment piece 102.

At 612, the garment piece 102 can be moved to the assembly area 310. In some embodiments, the garment piece 102 can be moved to a separate assembly area 310. In alternate embodiments in which the assembly area 310 and the cutting area 308 are the same, the garment piece 102 can remain on the cutting surface 318 or be moved to a temporary staging area. The garment piece 102 can be moved using a transport mechanism 306.

If more garment pieces 102 are to be cut, the garment production system 300 can repeat steps 608, 610 and/or 612 to cut additional garment pieces 102. The extra material left behind after a garment piece 102 is cut can be discarded, returned to the storage area 304, or kept within the cutting area 308. In some embodiments, the garment production system 300 can scan through remaining virtual pattern pieces 206 to determine if any additional garment pieces 102 can be cut from the extra material that remains in the cutting area 308. If another garment piece 102 can be cut from the remaining extra material, the garment production system 300 can cut that garment piece 102 from the extra material, move the new garment piece 102 to the assembly area 310, and repeat the process if any further garment pieces 102 can be cut from the remaining extra material. In some embodiments, if the remaining extra material is large enough to be used for other garment pieces 102 in the future, the extra material can be returned to the storage area 304 via a transport mechanism 306. In some embodiments, if the remaining extra material is too small to be used for garment pieces 102 in the currently selected garment design 200 or any other garment designs 200, the garment production system 300 can discard the extra material using the transport mechanism 306.

After the unit of material has been cut into one or more garment pieces 102, the garment pieces 102 have been moved to the assembly area 310, and the extra material has been removed from the cutting area 308, the garment production system 300 can return to step 608 to load a new unit of material into the cutting area 308. The garment production system 300 can repeat steps 608, 610 and 612 to cut more garment pieces 102 and move the garment pieces 102 to the assembly area 310 until all of the garment pieces 102 for the selected garment design 200 have been cut and moved to the assembly area 310.

In some embodiments assembly markings can be applied to each garment piece 102 at or before step 610 while the garment piece 102 is still in the cutting area 308. In alternate embodiments the assembly markings can be applied to each garment piece 102 at or after step 612, after the garment piece 102 has been moved to the assembly area 310. In alternate embodiments, the garment production system 300 can store in memory the location and orientation of each garment piece 102 within the garment production system 300 such that the garment production system 300 can determine which garment pieces 102 are to be coupled with which other garment pieces 102 and at which specific locations on each garment piece 102.

At 614, the garment pieces 102 can be assembled into the garment 100. The garment production system 300 can assemble the garment 100 by coupling the garment pieces 102 to one another as specified by the assembly instructions 204. In some embodiments, step 614 can occur while steps 608, 610, and 614 are being repeated for additional garment pieces 102, such that the garment production system 300 can begin assembling the garment 100 as soon as two garment pieces 102 that are to be coupled with one another reach the assembly area 310. In alternate embodiments, the garment production system 300 can wait to begin step 614 until all of the garment pieces 102 have been cut and moved to the assembly area 310.

In some embodiments, the assembly device 322 can couple each garment piece 102 to the final garment 100 one by one. In alternate embodiments, the assembly device 322 can couple certain garment pieces 102 into individual sections, which can then in turn be coupled with each other to create the final garment 100. The order in which garment pieces 102 are assembled can depend on the selected garment design 200, the associated virtual pattern 202 and/or the assembly instructions 204.

During step 614, transport mechanisms 306 can move two or more garment pieces 102 together according to the assembly instructions 204. The garment pieces 102 can be moved relative to the assembly device 322, which in some embodiments can operate to couple the garment pieces 102 together with seams along a straight line, curve, or any other path defined by the assembly instructions 204. The transport mechanisms 306 can fold, flip, spin, turn, move, or otherwise manipulate the garment pieces 102 such that they can be coupled according to the assembly instructions 204. Some assembly instructions 204 can dictate that more than one seam be made and/or that different seams be made on different edges, sides and/or faces of the garment pieces 102. By way of a non-limiting example, two garment pieces 102 that correspond to different virtual pattern pieces 206 can be cut and positioned face to face such that their edges are aligned. The aligned edges of the garment pieces 102 can be moved through an assembly device 322, such as a sewing machine, to create a seam coupling the garment pieces 102. One or more transport mechanisms 306 can then fold the two garment pieces 102 back on each other along the seam, such that the opposite faces of the garment pieces 102 are touching and the assembly device 322 can create a second seam coupling the garment pieces 102 along their edges or at any other position. The assembly devices 322 can couple garment pieces 102 using any sewing technique described by the assembly instructions 204.

The notion attachment devices 324 can attach notions 104 to the garment 100 or garment pieces 102 before the garment pieces 102 are coupled with one another, during assembly of the garment pieces 102, or after the garment 100 has been assembled. The notion attachment devices 324 can use the connection material as specified by the garment design 200.

In some embodiments, the garment production system 300 can dye the material into other colors, and/or apply a design onto the material through screen printing, embroidery, stitching, or any other desired method. Dying the material or applying a design can occur at any point during the process 600, such as before the garment pieces 102 are cut from the unit of material, before the garment pieces 102 are coupled with one another, during assembly of the garment 100, or after the garment 100 has been assembled.

At 616, the garment production system 300 can finalize the garment 100. The garment production system 300 can use the transport mechanisms 306 to move the garment 100 to the cutting area 308 and/or the assembly area 310 for any final alterations. In some embodiments, the garment production system 300 can perform a quality check on the completed garment 100. The quality check can include placing the garment on a hanger, mannequin, or other structure to verify that the garment pieces 102 have been properly assembled and the garment 100 will fit a body. In some embodiments, an optical scanner can be used to verify that the final garment 100 meets the specifications of the garment design 200. In some embodiments, the garment production system 300 can clean the garment 100 by removing loose elements such as fibers or threads, washing the garment 100, and/or dry cleaning the garment 100. In some embodiments the garment production system 300 can prepare the garment 100 for the customer by ironing the garment 100 and/or applying a scent to the garment 100.

At 618, the garment 100 can be removed from the garment production system 300. After the garment pieces 102 have been assembled, any notions 104 have been attached, and any dying or design applications have been completed, the garment production can be completed. A user can remove the garment 100 from the garment production system 300 to be provided to a customer, stocked within a store, or used for any other purpose.

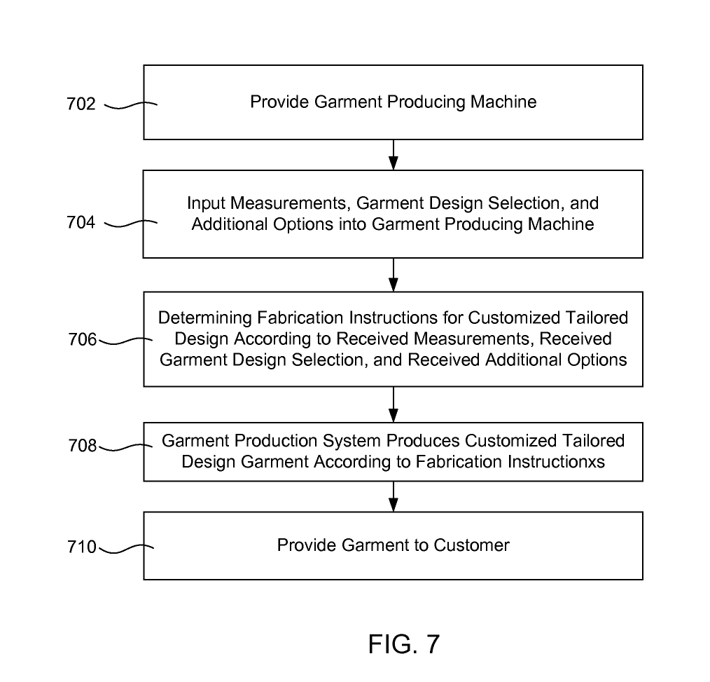

FIG. 7 depicts a flow chart of a method 700 of producing a customized tailored garment 100 on demand for a customer. At step 702, a garment producing machine can be provided. In some embodiments, the garment producing machine can be the garment production system 300 described above. In some embodiments, the garment producing machine can be provided within a store, such that the method 700 can be used with the garment producing machine to produce the customized tailored garment 100 on demand for a customer of the store. In alternate embodiments, the garment producing machine can be provided in an offsite location.

At step 704, measurements, a garment design selection, and additional options can be determined and input into the garment producing machine. The measurements can at least partially describe the body of the person who will wear the garment 100 once it has been produced. The measurements can be received from a customer, determined by a store employee, and/or determined by the garment producing machine. The store and/or the garment producing machine can have a plurality of garment design choices available for a customer to select. In some embodiments, the plurality of garment design choices can be a plurality of garment designs 200. In some embodiments, the customer or a store employee can also choose to configure additional options. Additional options can be alterations to the selected garment design, such as: changing the color and/or pattern of material to be used in the garment 100; changing the type of material to be used in the garment 100; selecting customized embroidery or other embellishments or features to be added to the garment 100, or any other desired alterations to the selected garment design. In alternate embodiments, the choice to configure additional options can be absent.

The measurements, garment design selection, and choices of additional options can be entered into the garment producing machine. In some embodiments, the customer can enter these selections directly into the garment producing machine. In other embodiments, the customer can inform a store employee of the customer's selections, and the store employee can input the measurements, garment design selection, and choices of additional options into the garment producing machine.

At step 706, the garment producing machine can determine fabrication instructions for a customized tailored garment according to the entered measurements, garment design selection, and/or choices of additional options. The fabrication instructions can describe information about the customized tailored garment, such as assembly steps, cutting patterns, sewing patterns, information about the shape, size, and number of garment pieces 102, types and locations of notions 104, material patterns and orientations, additional options, and/or any other information for producing a customized tailored garment. The garment producing machine can create and/or customize the fabrication instructions to describe steps to be taken by the garment producing machine to produce a customized garment 100 that is tailored to fit the body of the wearer described by the received measurements, and that matches the garment design selection and any additional options.

At step 708, the garment producing machine can produce the customized tailored garment 100 according to the fabrication instructions determined in step 706. The garment producing machine can follow the fabrication instructions to cut out garment pieces 102 and assemble the garment pieces 102 and notions 104 to create a customized tailored garment 100 according to the received measurements, garment design selection, and/or the chosen additional options.

At step 710, the customized tailored garment 100 produced by the garment producing machine can be removed from the garment producing machine and be sold and/or provided to the customer. In some embodiments, the customized tailored garment 100 can be provided to the customer within a prescribed period. By way of a non-limiting example, in some embodiments, the customized tailored garment 100 can be provided to the customer in the store during the same visit to the store in which the customer provided measurements and selected the garment design. In other embodiments, the produced customized tailored garment 100 can be held by the store for the customer to pick up during a later visit to the store, be shipped to the customer, or otherwise be provided to the customer.

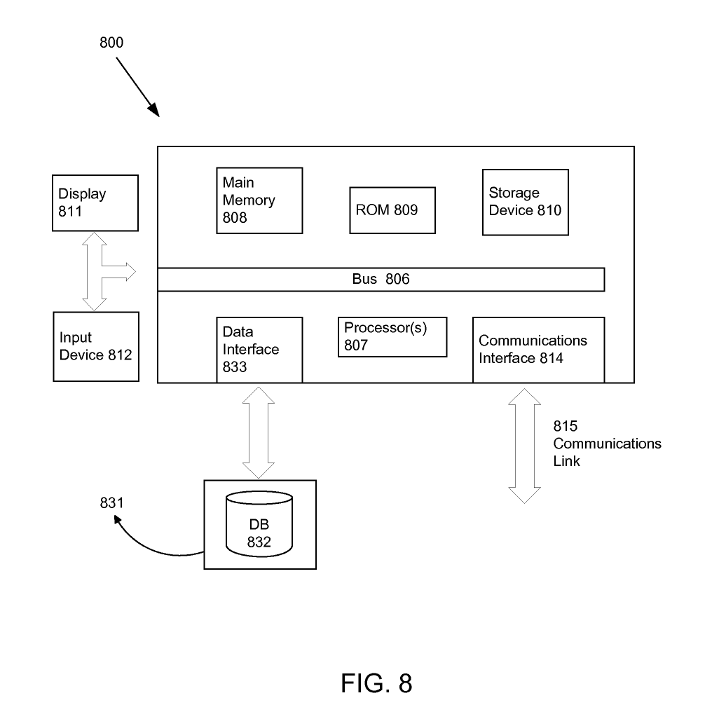

The execution of the sequences of instructions required to practice the embodiments may be performed by a computer system 800 as shown in FIG. 8. In an embodiment, execution of the sequences of instructions is performed by a single computer system 800. According to other embodiments, two or more computer systems 800 coupled by a communication link 815 may perform the sequence of instructions in coordination with one another. Although a description of only one computer system 800 will be presented below, however, it should be understood that any number of computer systems 800 may be employed to practice the embodiments.

A computer system 800 according to an embodiment will now be described with reference to FIG. 8, which is a block diagram of the functional components of a computer system 800. As used herein, the term computer system 800 is broadly used to describe any computing device that can store and independently run one or more programs.

Each computer system 800 may include a communication interface 814 coupled to the bus 806. The communication interface 814 provides two-way communication between computer systems 800. The communication interface 814 of a respective computer system 800 transmits and receives electrical, electromagnetic or optical signals, that include data streams representing various types of signal information, e.g., instructions, messages and data. A communication link 815 links one computer system 800 with another computer system 800. For example, the communication link 815 may be a LAN, in which case the communication interface 814 may be a LAN card, or the communication link 815 may be a PSTN, in which case the communication interface 814 may be an integrated services digital network (ISDN) card or a modem, or the communication link 815 may be the Internet, in which case the communication interface 814 may be a dial-up, cable or wireless modem.

A computer system 800 may transmit and receive messages, data, and instructions, including program, i.e., application, code, through its respective communication link 815 and communication interface 814. Received program code may be executed by the respective processor(s) 807 as it is received, and/or stored in the storage device 810, or other associated non-volatile media, for later execution.

In an embodiment, the computer system 800 operates in conjunction with a data storage system 831, e.g., a data storage system 831 that contains a database 832 that is readily accessible by the computer system 800. The computer system 800 communicates with the data storage system 831 through a data interface 833. A data interface 833, which is coupled to the bus 806, transmits and receives electrical, electromagnetic or optical signals, that include data streams representing various types of signal information, e.g., instructions, messages and data. In embodiments, the functions of the data interface 833 may be performed by the communication interface 814.

Computer system 800 includes a bus 806 or other communication mechanism for communicating instructions, messages and data, collectively, information, and one or more processors 807 coupled with the bus 806 for processing information. Computer system 800 also includes a main memory 808, such as a random access memory (RAM) or other dynamic storage device, coupled to the bus 806 for storing dynamic data and instructions to be executed by the processor(s) 807. The main memory 808 also may be used for storing temporary data, i.e., variables, or other intermediate information during execution of instructions by the processor(s) 807.

The computer system 800 may further include a read only memory (ROM) 809 or other static storage device coupled to the bus 806 for storing static data and instructions for the processor(s) 807. A storage device 810, such as a magnetic disk or optical disk, may also be provided and coupled to the bus 806 for storing data and instructions for the processor(s) 807.

A computer system 800 may be coupled via the bus 806 to a display device 811, such as, but not limited to, a cathode ray tube (CRT) or an LCD monitor, for displaying information to a user. An input device 812, e.g., alphanumeric and other keys, is coupled to the bus 806 for communicating information and command selections to the processor(s) 807.

According to one embodiment, an individual computer system 800 performs specific operations by their respective processor(s) 807 executing one or more sequences of one or more instructions contained in the main memory 808. Such instructions may be read into the main memory 808 from another computer-usable medium, such as the ROM 809 or the storage device 810. Execution of the sequences of instructions contained in the main memory 808 causes the processor(s) 807 to perform the processes described herein. In alternative embodiments, hard-wired circuitry may be used in place of or in combination with software instructions. Thus, embodiments are not limited to any specific combination of hardware circuitry and/or software.

The term “computer-usable medium,” as used herein, refers to any medium that provides information or is usable by the processor(s) 807. Such a medium may take many forms, including, but not limited to, non-volatile, volatile and transmission media. Non-volatile media, i.e., media that can retain information in the absence of power, includes the ROM 809, CD ROM, magnetic tape, and magnetic discs. Volatile media, i.e., media that can not retain information in the absence of power, includes the main memory 808. Transmission media includes coaxial cables, copper wire and fiber optics, including the wires that comprise the bus 806. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes may be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention may be implemented in a variety of computer systems. The various techniques described herein may be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner. Further, the storage elements of the exemplary computing applications may be relational or sequential (flat file) type computing databases that are capable of storing data in various combinations and configurations.

Although exemplary embodiments of the invention have been described in detail above, those skilled in the art will readily appreciate that many additional modifications are possible in the exemplary embodiments without materially departing from the novel teachings and advantages of the invention. Accordingly, these and all such modifications are intended to be included within the scope of this invention construed in breadth and scope in accordance with the appended claims.

What is claimed is:

1. A garment production system, comprising:
one or more transport mechanisms configured to manipulate material for one or more garment pieces;
one or more cutting tools configured to cut said material into said one or more garment pieces;
one or more assembly devices configured to couple said one or more garment pieces together to assemble a garment; and
a tensioning mechanism configured to hold said material against a cutting surface during cutting of said one or more garment pieces and assembly of said garment.

2. The garment production system of claim 1, further comprising:
a terminal configured to receive a garment design and measurements from a user;
wherein said garment design comprises information about said one or more garment pieces and assembly instructions for assembling said one or more garment pieces into said garment, and
wherein said measurements describe a wearer's body.

3. The garment production system of claim 2, further comprising a processor configured to alter said information about said one or more garment pieces according to said measurements, such that said garment will fit said wearer when said garment pieces are assembled according to said assembly instructions.

4. The garment production system of claim 1, wherein said tensioning mechanism is a vacuum table.

5. The garment production system of claim 1, wherein at least one of said one or more transport mechanisms is a robotic arm comprising one or more segments and a hand.

6. The garment production system of claim 5, wherein said hand has a plurality of grips configured to grasp said garment pieces.

7. The garment production system of claim 5, wherein said hand is transferable to a different robotic arm.

8. The garment production system of claim 1, wherein at least one of said one or more transport mechanisms is a bridge coupled with one or more rails, wherein said bridge comprises a motor configured to propel said bridge along said one or more rails.

9. The garment production system of claim 8, wherein said motor is a stepper motor.

10. The garment production system of claim 8, wherein one or more attachments are coupled with said bridge.

11. The garment production system of claim 10, wherein said one or more attachments are configured be propelled by a motor along the length of said bridge.

12. The garment production system of claim 10, wherein one of said one or more attachments is one of said one or more assembly devices.

13. The garment production system of claim 10, wherein one of said one or more attachments is one of said one or more cutting tools.

14. A method of garment production, comprising:
receiving in memory a garment design comprising information about a garment and assembly instructions for said garment, wherein said garment comprises one or more garment pieces and said assembly instructions are machine readable instructions that describe operations for assembling said one or more garment pieces into said garment;
transporting material associated with said garment pieces to a cutting area comprising a cutting tool;
cutting said material with said cutting tool into said garment pieces according to said garment design; and
assembling said garment by coupling said garment pieces with one another according to said assembly instructions.

15. The method of claim 14, further comprising:
receiving in memory measurements describing the body of a wearer; and
adjusting the dimensions of said garment pieces, based at least in part on said measurements, such that said garment will fit said wearer when the adjusted garment pieces are cut and assembled into said garment.

16. A method of producing a garment for a customer on demand, comprising:
providing a garment producing machine;
receiving measurements from a customer;
receiving a garment design selection from said customer;
entering said measurements and said garment design into said garment producing machine;
determining fabrication instructions for a customized tailored garment according to said measurements and said garment design;
activating production of said customized tailored garment with said garment producing machine, wherein said garment producing machine substantially automatically creates said customized tailored garment according to said fabrication instructions;
providing said garment to said customer within a prescribed period.

17. The method of claim 16, further comprising:
receiving one or more additional options from said customer;
entering said one or more additional options into said garment producing machine,
wherein said fabrication instructions are further determined according to said one or more additional options.

18. The method of claim 16, wherein said garment producing machine is provided within a store and said customized tailored garment is provided to said customer within said store after said garment producing machine has completed production of said customized tailored garment.
